(19) United States
(12) Patent Application Publication
(10) Pub. No.: US 2020/0065832 A1
(43) Pub. Date: Feb. 27, 2020

(54) AUTOMATED ASSESSMENT OF MEDIA CONTENT DESIRABILITY

(71) Applicant: Disney Enterprises, Inc., Burbank, CA (US)

(72) Inventors: Alexander Cherny, Porter Ranch, CA (US); Anthony M. Accardo, Los Angeles, CA (US)

(73) Assignee: DISNEY ENTERPRISES INC..

(21) Appl. No.: 16/106,817

(22) Filed: Aug. 21, 2018

(51) Int. Cl. G06Q 30/02

(52) U.S. Cl. CPC G06Q 30/0201; G06Q 30/0272; G06Q 30/0242; G06Q 30/0204

(57) ABSTRACT

A media content analysis system includes a computing platform having a hardware processor and a system memory storing a content assessment software code. The hardware processor executes the content assessment software code to, for each consumer of media content, receive usage data including timecode information, advertising consumption, and behavioral information corresponding to use of the media content by the consumer, and assess an engagement level for each of multiple timecode intervals of the media content based on an aggregate of the usage data. The content assessment software code also obtains metadata describing features presented by the media content during each timecode interval, for each timecode interval concatenates the engagement level with the metadata to produce an aggregate consumer engagement profile for the media content, and outputs an engagement visualization map of the media content based on the aggregate consumer engagement profile for rendering on a display.

### BACKGROUND

Media content in a wide variety of formats is consistently sought out and enjoyed by consumers. Nevertheless, the popularity of a particular item or items of media content, such as a movie, television (TV) series, or a particular TV episode can vary widely. Due to the resources often devoted to developing new content, the accuracy and efficiency with which the desirability of such content to consumers can be assessed has become increasingly important to producers, owners, and distributors of media content.

### SUMMARY

There are provided systems and methods for automating assessment of media content desirability, substantially as shown in and/or described in connection with at least one of the figures, and as set forth more completely in the claims.

### BRIEF DESCRIPTION OF THE DRAWINGS

FIG. 1 shows an exemplary system for automating assessment of media content desirability, according to one implementation;

FIG. 2 shows an exemplary user interface provided by a system for automating assessment of media content desirability, according to one implementation;

FIG. 3 shows a flowchart presenting an exemplary method for automating assessment of media content desirability, according to one implementation; and

FIG. 4 shows a flowchart presenting an exemplary method for assessing the desirability of changes to media content, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for automating assessment of media content desirability to consumers that address and overcome the deficiencies in the conventional art. By receiving usage data describing use of an item of media content by consumers, the present solution collects the information needed to analyze the desirability of the media content to those consumers. Such usage data may include timecode information identifying the beginning and end of a use interval, advertising consumption, and information describing the behavior of individual consumers while they use the media content, for example.

In addition, by assessing an engagement level for each of multiple timecode intervals of the media content and concatenating or linking the engagement level with metadata describing features presented by the media content during the same timecode interval, the present solution enables identification of the characteristics that make content more, as well as less desirable. Moreover, by outputting an engagement visualization map for displaying aggregate consumer engagement with the media content in a format that can be intuitively understood by a human system user, the present solution efficiently and effectively communicates the results of its automated assessment.

It is noted that, as used in the present application, the terms “automation,” “automated”, and “automating” refer to systems and processes that do not require the participation of a human user, such as a human reviewer or analyst. Although, in some implementations, a human reviewer or analyst may interact with an assessment provided by the automated systems and according to the automated methods described herein, that human involvement is optional. Thus, the methods described in the present application may be performed under the control of hardware processing components of the disclosed automated systems.

It is further noted that, as used in the present application, the expressions “use media content” and “consume media content” can be used interchangeably to describe actions involved in the enjoyment of media content. Thus, for example, using or consuming media content in the form of movie or television (TV) content refers to viewing and/or listening to the content. By way of analogy, using or consuming music content refers to listening to the content, while using or consuming literary content in the form of a digital book refers to reading the content, and the like.

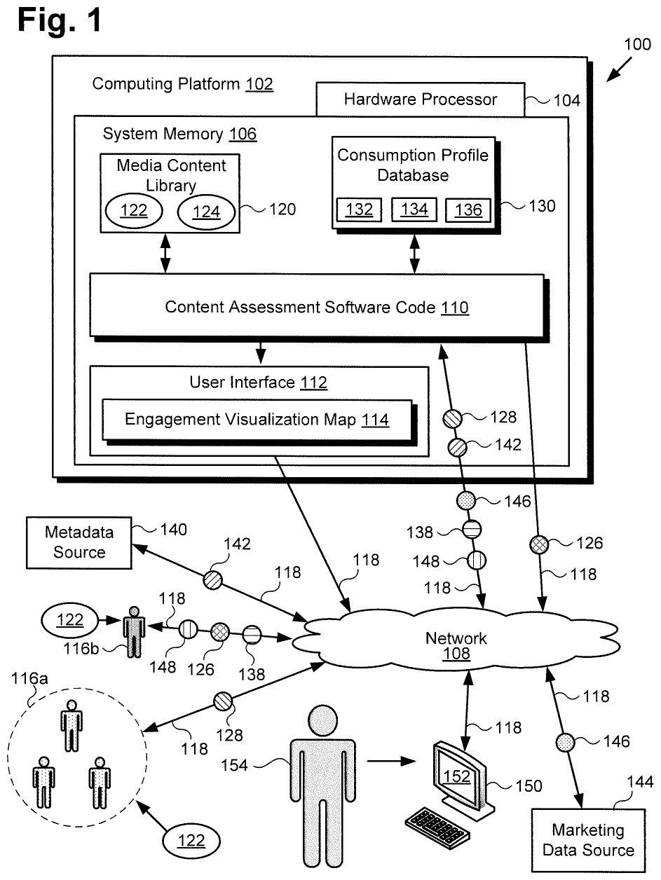

FIG. 1 shows an exemplary system for automating assessment of media content desirability, according to one implementation. As shown in FIG. 1, media content analysis system 100 includes computing platform 102 having hardware processor 104 and system memory 106 implemented as a non-transitory storage device. According to the present exemplary implementation, system memory 106 stores content assessment software code 110 providing user interface 112 including engagement visualization map 114, as well as media content media content library 120 and consumption profile database 130. Also shown in FIG. 1 are individual items of media content 122 and 124, such as individual movies or episodes of TV programming, for example, and consumption profiles 132, 134, and 136 stored in consumption profile database 130.

As further shown in FIG. 1, media content analysis system 100 is implemented within a use environment including communication network 108, computing device 150 including display 152, and system user 154 utilizing computing device 150 to access media content analysis system 100. In addition, FIG. 1 shows network communication links 118 of communication network 108 interactively connecting computing device 150 with media content analysis system 100. Also shown in FIG. 1 are consumers 116a and another consumer 116b of media content 122, metadata source 140 providing metadata 142, marketing data source 144 providing marketing data 146, usage data 128 for consumers 116a, first usage data 138 and second usage data 148 for another consumer 116b, and customized media content 126.

It is noted that, although the present application refers to content assessment software code 110 as being stored in system memory 106 for conceptual clarity, more generally, system memory 106 may take the form of any computer-readable non-transitory storage medium.

The expression “computer-readable non-transitory storage medium,” as used in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

It is further noted that although FIG. 1 depicts content assessment software code 110, media content library 120, and consumption profile database 130 as being co-located in system memory 106, that representation is merely provided as an aid to conceptual clarity. More generally, media content analysis system 100 may include one or more computing platforms 102, such as computer servers for example, which may be co-located, or may form an interactively linked but distributed system, such as a cloud based system, for instance. As a result, hardware processor 104 and system memory 106 may correspond to distributed processor and memory resources within media content analysis system 100.

According to the implementation shown by FIG. 1, system user 154 may utilize computing device 150 to interact with media content analysis system 100 over communication network 108. In one such implementation, computing platform 102 may correspond to one or more web servers, accessible over a packet-switched network such as the Internet, for example. Alternatively, computing platform 102 may correspond to one or more computer servers supporting a local area network (LAN), or included in another type of limited distribution network.

Although computing device 150 is shown as a desktop computer in FIG. 1, that representation is also provided merely as an example. More generally, computing device 150 may be any suitable mobile or stationary computing device or system that implements data processing capabilities sufficient to support connections to communication network 108, and implement the functionality ascribed to computing device 150 herein. For example, in other implementations, computing device 150 may take the form of a laptop computer, tablet computer, or smartphone, for example.

System user 154, who may be a media content analyst or content creator, for example, may utilize computing device 150 to interact with media content analysis system 100 via user interface 112. For example, system user 154 may utilize user interface 112 to view, interpret, and study engagement visualization map 114, generated by content assessment software code 110, and rendered on display 152 of computing device 150. Display 152 of computing device 150 may take the form of a liquid crystal display (LCD), a light-emitting diode (LED) display, an organic light-emitting diode (OLED) display, or another suitable display screen that performs a physical transformation of signals to light. It is noted that, in various implementations, engagement visualization map 114, when generated by content assessment software code 110, may be stored in system memory 106 and/or may be copied to non-volatile storage (not shown in FIG. 1).

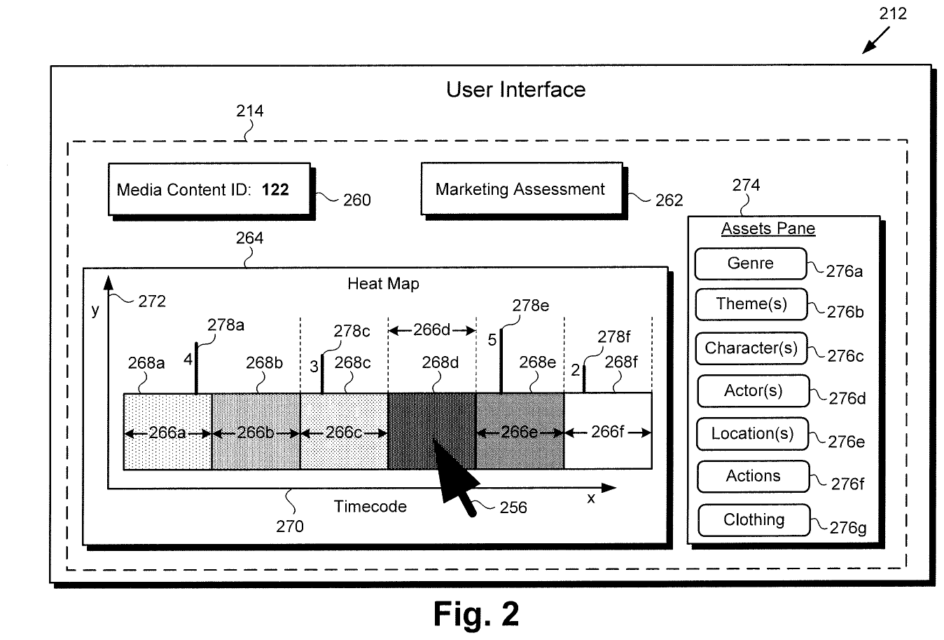

FIG. 2 shows exemplary user interface 212 provided by content assessment software code 110 of media content analysis system 100, according to one implementation. As shown in FIG. 2 exemplary user interface 212 is displaying engagement visualization map 214 including media content identification (ID) field 260, marketing assessment 262, content desirability heat map 264, and assets pane 274. Also shown in FIG. 2 is cursor 256 usable by system user 154 to interact with engagement visualization map 214.

User interface 212 and engagement visualization map 214 correspond respectively in general to user interface 112 and engagement visualization map 114, in FIG. 1. That is to say, user interface 212 and engagement visualization map 214 may share any of the features and/or functionality attributed to respective user interface 112 and engagement visualization map 114 by the present disclosure, and vice versa. Thus, although not shown in FIG. 1, engagement visualization map 114 may include any or all of media content ID field 260, marketing assessment 262, content desirability heat map 264, and assets pane 274.

According to the present exemplary implementation, the desirability of media content 122 to consumers 116a, in FIG. 1, is the subject of the assessment resulting in generation of engagement visualization map 114/214, as shown by media content ID field 260. Engagement visualization map 114/214 provides a visual interpretation of how consumers 116a engage with media content 122, as assessed based on usage data 128.

Referring to content desirability heat map 264 of engagement visualization map 114/214, media content 122 is segregated into timecode intervals 266a, 266b, 266c, 266d, 266e, and 266f (hereinafter “timecode intervals 266a-266f”) arranged sequentially along horizontal x axis 270. In addition to timecode intervals 266a-266f, content desirability heat map 264 includes engagement levels 268a, 268b, 268c, 268d, 268e, and 268f (hereinafter “engagement levels 268a-268f”) of each of those respective timecode intervals, displayed concurrently. Thus, timecode interval 266a has engagement level 268a, timecode interval 266b has engagement level 268b, timecode interval 266c has engagement level 268c, and so forth.

It is noted that each of engagement levels 268a-268f can be visually distinguished by its fill pattern or darkness in FIG. 2. However, the present inventors contemplate use of color, rather than fill pattern or darkness, to visually distinguish the desirability of timecode intervals 266a-266f. That is to say, for example, relatively darkly filled timecode interval 268d may correspond to a hot color such as red, and may indicate a high level of content desirability. By contrast, and again merely by way of example, unfilled timecode interval 268f may correspond to a cool color such as blue, and may indicate a low level of content desirability.

As noted above, media content 122 may take a variety of forms. For instance, media content 122 may be video content, such as a movie or an episode of TV programming, as also noted above. Timecode intervals 266a-266f of media content 122 may also correspond to a variety of content segments according to the nature of media content 122. For example, where media content 122 is video content, timecode intervals 266a-266f of media content 122 may correspond to one or more “shots” of video.

It is noted that, as used in the present application, a “shot” refers to a sequence of video frames that is captured from a unique camera perspective without cuts and/or other cinematic transitions. Thus, in one implementation, each of timecode intervals 266a-266f of media content 122 may correspond to a single shot of video content including multiple individual frames of video. However, in other implementations, each of timecode intervals 266a-266f of media content 122 may correspond to a scene or scenes including multiple shots.

Content desirability heat map 264 also includes advertising or “ad” information in the form of vertical ad bars 278a, 278c, 278e, and 278f for each timecode interval that includes advertising. Vertical add bars 278a, 278c, 278e, and 278f extend in the direction of y axis 272 and have respective heights corresponding to the number of ads included in a particular ad pod. Thus, for example, ad bar 278a indicates that the ad pod included in somewhat undesirable timecode interval 266a, as shown by engagement level 268a, includes four ads, while ad bar 278c indicates that the ad pod included in more desirable timecode interval 266c includes three ads. Analogously, ad bar 278e indicates that the ad pod included in still more desirable timecode interval 266e includes five ads, while ad bar 278f indicates that the ad pod included in least desirable timecode interval 266f includes only two ads.

Assets pane 274 lists categories that are selectable by system user 154, and identifies features presented during one or more of timecode intervals 266a-266f based on a selection of one or more of timecode intervals 266a-266f by system user 154. For example, as shown in FIG. 2, system user 154 has used cursor 256 to select timecode interval 266d. In that use case, assets pane 274 lists the exemplary features genre 276a, theme or themes 276b, character or characters 276c, actor or actors 276d, location or location(s) 276e, actions 276f, and clothing 276g depicted in or corresponding to timecode interval 266d of media content 122.

As shown in FIG. 2, in some implementations, engagement visualization map 114/214 may include marketing assessment 262. Marketing assessment 262 is provided as a visual representation corresponding to marketing data 146, in FIG. 1. Marketing data 146 may identify one or more channels of communication utilized to inform one or more of consumers 116a about media content 122 prior to its consumption by consumers 116a. For example, marketing data 146 may identify use of text messaging, email, or website banner advertising to inform one or more of consumers 116a of media content 122. Marketing assessment 262 may be provided in the form of a brief report, or as a marketing assessment score, for example.

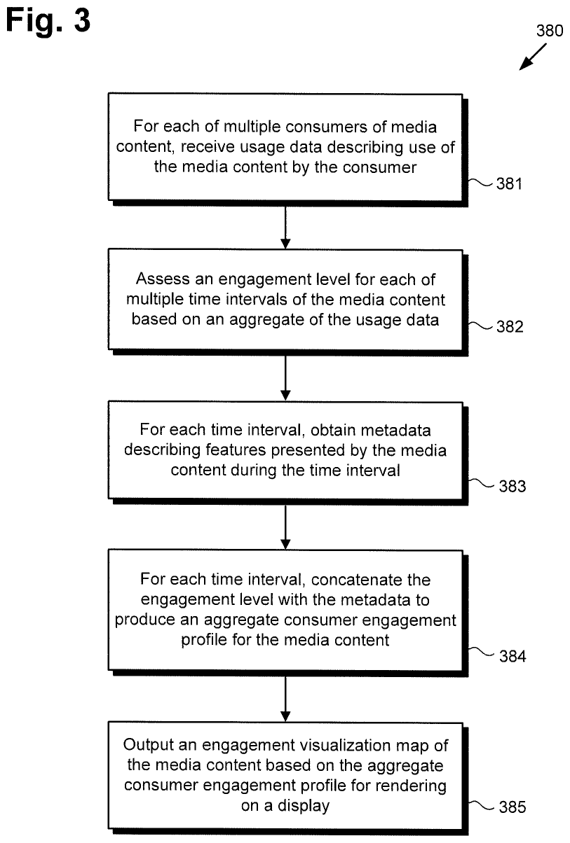

The functionality of content assessment software code 110 will be further described by reference to FIG. 3. FIG. 3 shows flowchart 380 presenting an exemplary method for use by a system, such as media content analysis system 100, for automating assessment of media content desirability. With respect to the method outlined in FIG. 3, it is noted that certain details and features have been left out of flowchart 380 in order not to obscure the discussion of the inventive features in the present application.

Referring to FIG. 3 in combination with FIGS. 1 and 2, flowchart 380 begins with, for each of consumers 116a of media content 122, receiving usage data 128 describing use of media content 122 by that consumer (action 381). Usage data 128 may include session data carrying timecode information, information about advertising consumption, and behavioral information corresponding to the use of media content 122 by each of consumers 116a.

Session data included in usage data 128 may include timestamps identifying when each of consumers 116a starts to use or consume media content 122, as well as timestamps identifying when each of consumers 116a stops using or consuming media content 122. Usage data 128 may further include information about the number, and/or duration, and/or type of advertising consumed by each of consumers 116a while using media content 122.

Behavioral information included in usage data 128 may take a variety of forms. In some implementations, behavioral information included in usage data 128 may include data corresponding to interactions of each of consumers 116a with a device or system used by each consumer to watch, listen to, or otherwise enjoy media content 122. For example, such behavioral information may include data reporting the mouse clicks, cursor movements, finger taps, or keyboard inputs to a playback device executed by the consumer while consuming media content 122. In addition, or alternatively, behavioral information included in usage data 128 may report command actions by the consumer during consumption of media content 122. Examples of command actions by each of consumers 116a may include logging in to a subscription plan in order to consume media content 122, and/or pause, rewind, and fast forward commands entered during consumption of media content 122.

In some implementations, behavioral information included in usage data 128 may include data reporting use of a secondary device by consumers 116a while consuming media content 122 on another device. For example, one or more of consumers 116a may consume media content 122 using a personal computer, but may have their attention diverted through concurrent use of a secondary device in the form of a mobile phone or gaming console.

According to some implementations, behavioral information included in usage data 128 may include data reporting activities engaged in by consumers 116a while consuming media content 122. Such activity related behavioral information may include whether the consumer is physically active, e.g., walking or jogging, while consuming media content 122, or whether the consumer is sedentary during consumption. Alternatively, or in addition, such activity related behavioral information may include whether the consumer is indoors or outdoors, or is commuting or otherwise traveling during consumption of media content 122.

Usage data 128 describing use of media content 122 by each of consumers 116a may be received by content assessment software code 110, executed by hardware processor 104. It is noted that, in some implementations, usage data 128 may be received from devices used respectively by each of consumers 116a to consume media content 122 as a telemetry “heartbeat” of usage data at periodic intervals during consumption of media content 122. For instance, in some implementations, such a heartbeat of usage data 128 may be received from a device used to consume media content 122 approximately every thirty seconds during consumption of media content 122.

Flowchart 380 continues with assessing an engagement level for each of multiple timecode intervals of media content 122 based on an aggregate of usage data 128 (action 382). Referring to FIG. 2, as discussed above, media content 122 may be segregated into timecode intervals 266a-266f each associated with a respective one of engagement levels 268a-268f. In other words, timecode interval 266a has engagement level 268a, timecode interval 266b has engagement level 268b, timecode interval 266c has engagement level 268c, and so forth. Engagement levels 268a-268f for each of respective time code intervals 266a-266f may be assessed by content assessment software code 110, executed by hardware processor 104.

Engagement levels 268a-268f may be assessed in part based on the aggregate session data included in usage data 128. For example, session data for each of consumers 116a can be overlaid to identify high consumption timecode intervals of media content 122, i.e., timecode intervals 266d and 266e, as well as low consumption time code intervals of media content 122, i.e., timecode intervals 266a and 266f.

In some implementations, the assessment resulting in engagement levels 268a-268f may include weighting the session data included in usage data 128 with behavioral information included in usage data 128. For example, a high consumption timecode interval during which many of consumers 116a were concurrently using a secondary device, or were engaged in actions indicative of distraction, e.g., finger taps or mouse clicks, might be assessed as having a lower engagement level than if the assessment were based on aggregate consumption alone. Analogously, a lower consumption timecode interval during which behavioral information indicates that consumers 116a are focused on media content 122 might be assessed as having a higher engagement level than if the assessment were based on aggregate consumption alone.

Flowchart 380 continues with, for each of timecode intervals 266a-266f, obtaining metadata 142 describing features presented by media content 122 during the timecode interval (action 383). Referring to FIG. 1, in some implementations, metadata 142 may be obtained from metadata source 140 via communication network 108 and network communication links 118. Metadata source 140 may be a metadata library or other repository of metadata describing features included in media content 122 and 124 stored in media content library 120. Metadata 142 may be obtained by content assessment software code 110, executed by hardware processor 104.

Referring to FIG. 2, in the exemplary use case shown by that figure, system user 154 has used cursor 256 to select timecode interval 266d. Metadata 142 describes features presented during timecode interval 266d. For instance, and as shown by assets pane 274, the exemplary features genre 276a, theme or themes 276b, character or characters 276c, actor or actors 276d, location or location(s) 276e, action 276f, and clothing 276g are depicted in or correspond to timecode interval 266d of media content 122.

Flowchart 380 continues with, for each of timecode intervals 266a-266f, concatenating or linking its respective engagement level with metadata 142 describing the features presented during that timecode interval to produce an aggregate consumer engagement profile for media content 122 (action 384). For example, and referring to FIG. 2, engagement level 268d of timecode interval 266d may be concatenated with metadata 142 describing the features listed by assets pane 274. A similar process may be performed for each of timecode intervals 266a-266f to produce the aggregate consumer engagement profile. Action 384 effectively filters metadata 142 based on timecode intervals 266a-266f. Engagement levels 268a-268f of respective timecode intervals 266a-266f may be concatenated with metadata 142 for each of those timecode intervals to produce the aggregate consumer engagement profile by content assessment software code 110, executed by hardware processor 104.

Flowchart 380 can conclude with outputting engagement visualization map 114/214 of media content 122 based on the aggregate consumer engagement profile produced in action 384 for rendering on display 152 of computing device 150 (action 385). It is noted that engagement visualization map 114/214 is a visual representation of the aggregate consumer engagement profile produced in action 384. As described above, engagement visualization map 114/214 may identify media content 122 through media content ID field 260, and may include content desirability heat map 264 as well as assets pane 274. It is further noted that displaying assets pane 274 alongside content desirability heat map 264 enables correlation of content features with consumer engagement. For example, in a use case in which multiple episodes of TV programming content are compared using engagement visualization maps corresponding to engagement visualization map 114/214, patterns linking features presented by media content with consumption of that content may advantageously emerge.

Engagement visualization map 114/214 may be output by content assessment software code 110, executed by hardware processor 104, for example by being transferred to computing device 150 via communication network 108 and network communication links 118. Engagement visualization map 114/214 may then be rendered on display 152 by computing device 150 and may be presented to system user 154 via user interface 112/212.

Although not included in the exemplary outline provided by flowchart 380, in some implementations, the present method may further include, for each of at least some of consumers 116a of media content 122, obtaining marketing data 146 identifying a channel of communication utilized to inform that consumer about media content 122. In some implementations, as shown in FIG. 1, marketing data 146 may be obtained from marketing data source 144 via communication network 108 and network communication links 118. Marketing data 146 may be obtained by content assessment software code 110, executed by hardware processor 104.

As noted above, marketing data 146 may identify one or more channels of communication utilized to inform one or more of consumers 116a about media content 122 prior to its consumption by consumers 116a. For example, marketing data 146 may identify use of text messaging, email, or website banner advertising to inform one or more of consumers 116a of media content 122.

In implementations in which content assessment software code 110 obtains marketing data 146 for at least some of consumers 116a, content assessment software code 110 may be further executed by hardware processor 104 to, for each of those consumers, correlate usage data 128 with marketing data 146 to generate marketing assessment 262. Moreover, as shown in FIG. 2 and noted above, in some implementations, engagement visualization map 114/214 may include marketing assessment 262. Marketing assessment 262 may be provided in the form of a brief report, or as a marketing assessment score, for example assessing the effectiveness of the marketing mode used to communication with various consumers among consumers 116a.

Thus, the method presented by flowchart 380 automates assessment of the desirability of media content 122 to consumers 116a. Furthermore, the method presented by flowchart 380 advantageously enables a human analyst or content creator, such as system user 154, to discover features and advertising characteristics of media content that may make such content more, or less, desirable to consumers 116a.

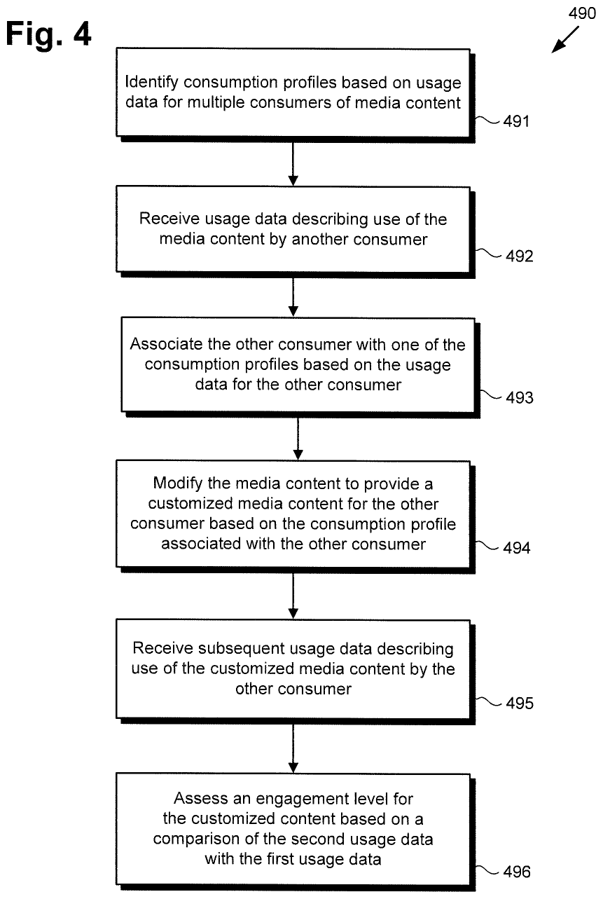

It is noted that, in some implementations, the automated solution for automating assessment of media content desirability disclosed in the present application may include additional actions related to machine learning. Referring to FIG. 4, FIG. 4 shows flowchart 490 presenting an exemplary method for assessing the desirability of changes to media content, according to one implementation.

Flowchart 490 begins with identifying consumption profiles 132, 134, 136 based on usage data 128 for consumers 116a (action 491). Consumption profiles 132, 134, 136 may be identified based upon similarities in consumption volume, ad tolerance, or correlation of particular features described by metadata 142 with engagement level among subgroups of consumers 116a. Identification of consumption profiles 132, 134, and 136 may be performed by content assessment software code 110, executed by hardware processor 104.

As a specific example, consumption profile 132 may correspond to a subgroup of consumers 116a for whom engagement levels 268a-268f are negatively correlated with ad consumption. That is to say, the more ads are present in a particular timecode interval, the lower the engagement level for that timecode interval. As another example, consumption profile 134 may correspond to a subgroup of consumers 116a for whom engagement levels 268a-268f are insensitive to ad consumption for certain genres of content, for example science fiction, or romance, or when a particular actor appears during the timecode interval. As yet another example, consumption profile 136 may correspond to a subgroup of consumers 116a identified as heavy users of secondary devices during consumption of media content 122.

Flowchart 490 continues with receiving first usage data 138 for another consumer 116b describing use of media content 122 by another consumer 116b (action 492). First usage data 138 corresponds in general to usage data 128, described above, and may share any of the characteristics attributed to that corresponding feature by the present disclosure. Thus, analogous to usage data 128, first usage data 138 may include session data carrying timecode information, information about advertising consumption, and behavioral information corresponding to the use of media content 122 by another user 116b. Moreover, the session data, advertising consumption information, and behavioral information included in first usage data 138 may share any of the characteristics of the session data, advertising consumption information, and behavioral information included in usage data 128 and described above.

First usage data 138 describing use of media content 122 by another consumer 116b may be received by content assessment software code 110, executed by hardware processor 104. It is noted that, like usage data 128, in some implementations first usage data 188 may be received from a device used by another consumer 116b to consume media content 122 as a usage data “heartbeat” at periodic intervals during consumption of media content 122. For instance, in some implementations, such a heartbeat of first usage data 138 may be received from a device used by another consumer 116b to consume media content 122 approximately every thirty seconds during consumption of media content 122.

Flowchart 490 continues with associating another consumer 116b with one of consumption profiles 132, 134, 136 based on first usage data 138 (action 493). Association of another consumer 116b with one of consumption profiles 132, 134, 136 may be performed by content assessment software code 110, executed by hardware processor 104, and may be based on similarities between first usage data 138 and one of consumption profiles 132, 134, 136.

Flowchart 490 continues with modifying media content 122 to provide customized media content 126 for another consumer 116b based on the consumption profile with which another consumer 116b is associated (action 494). For example, where another consumer 116b is associated with a consumption profile that has engagement level negatively correlated with advertising consumption, customized media content 126 may have advertising more uniformly spread out among timecode intervals 266a-266f so that another consumer 116b does not encounter large ad pods, e.g., more than three ads in sequence.

As another example, where another consumer 116b is associated with a consumption profile that is insensitive to ad consumption for timecode intervals in which a particular actor appears, customized media content 126 may include more timecode intervals in which the actor appears, even if only as a peripheral character or one without speaking lines. Media content 122 may be modified to provide customized media content 126 for another consumer 116b by content assessment software code 110, executed by hardware processor 104. It is noted that, in some implementations, modification of media content 122 to provide customized media content 126 may be performed in real-time with respect to consumption of media content 122/126 by another consumer 116b. That is to say, in those implementations, first usage data 138 may be received and customized media content 126 may be provided as a substitute for media content 122 while another consumer 116b is using media content 122.

In some implementations, flowchart 490 continues with receiving second usage data 148 for another consumer 116b describing use of customized media content 126 by another consumer 116b (action 495). Second usage data 148 corresponds in general to usage data 128 and first usage data 138, described above, and may share any of the characteristics attributed to those corresponding features by the present disclosure. Thus, analogous to usage data 128 and first usage data 138, second usage data 148 may include session data carrying timecode information, information about advertising consumption, and behavioral information corresponding to the use of customized media content 126 by another user 116b.

Moreover, it is noted that the session data, advertising consumption information, and behavioral information included in second usage data 148 may share any of the characteristics of the session data, advertising consumption information, and behavioral information included in usage data 128 and first usage data 138 as described above. Second usage data 148 describing use of customized media content 126 by another consumer 116b may be received by content assessment software code 110, executed by hardware processor 104.

Flowchart 490 can conclude with assessing the desirability of customized media content 126 to another consumer 116b based on a comparison of second usage data 148 with first usage data 138 (action 496). Assessment of the desirability of customized media content 126 to another consumer 116b based on the comparison of second usage data 148 with first usage data 138 may be performed by content assessment software code 110, executed by hardware processor 104.

The comparison of second usage data 148 with first usage data 138 performed in action 496 may result in correction to or validation of the modification made to media content 122 based on the consumption profile with which another consumer 116b is associated. For example, where comparison of second usage data 148 with first usage data 138 shows no significant increase in engagement of another consumer 116b with customized media content 126, content assessment software code may learn that the modification made in action 494 failed. By contrast, where comparison of second usage data 148 with first usage data 138 shows a significant increase in engagement of another consumer 116b with customized media content 126, content assessment software code may learn that the modification made in action 494 was successful and merits future use.

In other words, comparison of second usage data 148 with first usage data 138 by content assessment software code 110 may advantageously be used as training data by content assessment software code 110. Content assessment software code 110 may generate key performance indicators (KPIs) that drive the evolution of content assessment software code 110 based on that training data. For example, content assessment software code 110 may alter its process for automated modification of media content 122 based on that training data. Moreover, in some implementations, content assessment software code 110 may alter the composition of usage data 128, as well as the factors and/or weightings applied to those factors when used to assess engagement levels in action 382. In other words, in some implementations, content assessment software code 110 may be configured to learn from comparison of second usage data 148 with first usage data 138 in order to improve automated assessment of media content desirability in the future.

Thus, the present application discloses systems and methods for automating assessment of media content desirability to consumers. By receiving usage data describing use of an item of media content by consumers, the present solution collects the information needed to analyze the desirability of the media content to those consumers. In addition, by assessing an engagement level for each of multiple timecode intervals of the media content and concatenating the engagement level with metadata describing features presented by the media content during the same timecode interval, the present solution enables identification of the characteristics that make content more desirable. Moreover, by outputting an engagement visualization map for displaying aggregate consumer engagement with the media content in a format that can be intuitively understood by a human system user, the present solution efficiently and effectively communicates the results of its automated assessment. Consequently, the systems and methods disclosed herein represent an improvement to a computer system configured to analyze media content, due at least in part to the synergies and improved computational efficiency resulting from automated performance of such an analysis.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A media content analysis system comprising:
a computing platform including a hardware processor and a system memory storing a content assessment software code;
the hardware processor configured to execute the content assessment software code to:
for each of a plurality of consumers of a media content, receive a usage data describing use of the media content by the consumer, the usage data including timecode information, advertising consumption, and behavioral information corresponding to the use of the media content by the consumer;
assess an engagement level for each of a plurality of timecode intervals of the media content based on an aggregate of the usage data;
for each of the plurality of timecode intervals, obtain metadata describing a plurality of features presented by the media content during the time interval;
for each of the plurality of timecode intervals, concatenate the engagement level with the metadata to produce an aggregate consumer engagement profile for the media content; and
output an engagement visualization map of the media content based on the aggregate consumer engagement profile for rendering on a display.

2. The media content analysis system of claim 1, wherein the engagement visualization map comprises a heat map including the engagement level of each of the plurality of timecode intervals displayed concurrently.

3. The media content analysis system of claim 2, wherein the engagement visualization map further comprises an assets pane identifying the plurality of features presented during at least one of the plurality of timecode intervals based on a selection of the at least one of the plurality of timecode intervals by a system user.

4. The media content analysis system of claim 1, wherein the hardware processor is further configured to execute the content assessment software code to:
for each of at least some of the plurality of consumers, obtain marketing data identifying a channel of communication utilized to inform the consumer about the media content; and
for the each of the at least some of the plurality of consumers, correlate the usage data with the marketing data to generate a marketing assessment.

5. The media content analysis system of claim 4, wherein the engagement visualization map includes the marketing assessment.

6. The media content analysis system of claim 1, wherein the hardware processor is further configured to execute the content assessment software code to:
identify a plurality of consumption profiles based on the usage data for the plurality of consumers;
receive a first usage data for another consumer describing use of the media content by the another consumer, the first usage data including timecode information, advertising consumption, and behavioral information corresponding to the use of the media content by the another consumer;
associate the another consumer with one of the plurality of consumption profiles based on the first usage data; and
modify the media content to provide a customized media content for the another consumer based on the one of the plurality of consumption profiles associated with the another consumer.

7. The media content analysis system of claim 6, wherein the hardware processor is further configured to execute the content assessment software code to:
receive a second usage data for the another consumer describing use of the customized media content by the another consumer, the second usage data including timecode information, advertising consumption, and behavioral information corresponding to the use of the customized media content by the another consumer; and
assess a desirability of the customized content to the another consumer based on a comparison of the second usage data with the first usage data.

8. A method for use by a media content analysis system including a computing platform having a hardware processor and a system memory storing a content assessment software code, the method comprising:
for each of a plurality of consumers of a media content, receiving, by the content assessment software code executed by the hardware processor, a usage data describing use of the media content by the consumer, the usage data including timecode information, advertising consumption, and behavioral information corresponding to the use of the media content by the consumer;
assessing, by the content assessment software code executed by the hardware processor, an engagement level for each of a plurality of timecode intervals of the media content based on an aggregate of the usage data;
for each of the plurality of timecode intervals, obtaining, by the content assessment software code executed by the hardware processor, metadata describing a plurality of features presented by the media content during the timecode interval;
for each of the plurality of timecode intervals, concatenating, by the content assessment software code executed by the hardware processor, the engagement level with the metadata to produce an aggregate consumer engagement profile for the media content; and
outputting, by the content assessment software code executed by the hardware processor, an engagement visualization map of the media content based on the aggregate consumer engagement profile for rendering on a display.

9. The method of claim 8, wherein the engagement visualization map comprises a heat map including the engagement level of each of the plurality of timecode intervals displayed concurrently.

10. The method of claim 9, wherein the engagement visualization map further comprises an assets pane identifying the plurality of features presented during at least one of the plurality of timecode intervals based on a selection of the at least one of the plurality of timecode intervals by a system user.

11. The method of claim 8, further comprising:
for each of at least some of the plurality of consumers, obtaining, by the content assessment software code executed by the hardware processor, marketing data identifying a channel of communication utilized to inform the consumer about the media content; and
for the each of the at least some of the plurality of consumers, correlating, by the content assessment software code executed by the hardware processor, the usage data with the marketing data to generate a marketing assessment.

12. The method of claim 11, wherein the engagement visualization map includes the marketing assessment.

13. The method of claim 8, further comprising:
identifying, by the content assessment software code executed by the hardware processor, a plurality of consumption profiles based on the usage data for the plurality of consumers;
receiving, by the content assessment software code executed by the hardware processor, a first usage data for another consumer describing use of the media content by the another consumer, the first usage data including timecode information, advertising consumption, and behavioral information corresponding to the use of the media content by the another consumer;
associating, by the content assessment software code executed by the hardware processor, the another consumer with one of the plurality of consumption profiles based on the first usage data; and
modifying, by the content assessment software code executed by the hardware processor, the media content to provide a customized media content for the another consumer based on the one of the plurality of consumption profiles associated with the another consumer.

14. The method of claim 13, further comprising:
receiving, by the content assessment software code executed by the hardware processor, a second usage data for the another consumer describing use of the customized media content by the another consumer, the second usage data including timecode information, advertising consumption, and behavioral information corresponding to the use of the customized media content by the another consumer; and
assessing, by the content assessment software code executed by the hardware processor, a desirability of the customized content to the another consumer based on a comparison of the second usage data with the first usage data.

15. A computer-readable non-transitory medium having stored thereon instructions, which when executed by a hardware processor, instantiate a method comprising:
for each of a plurality of consumers of a media content, receiving a usage data describing use of the media content by the consumer, the usage data including timecode information, advertising consumption, and behavioral information corresponding to the use of the media content by the consumer;
assessing an engagement level for each of a plurality of timecode intervals of the media content based on an aggregate of the usage data;
for each of the plurality of timecode intervals, obtaining metadata describing a plurality of features presented by the media content during the timecode interval;
for each of the plurality of timecode intervals, concatenating the engagement level with the metadata to produce an aggregate consumer engagement profile for the media content; and
outputting an engagement visualization map of the media content based on the aggregate consumer engagement profile for rendering on a display.

16. The computer-readable non-transitory medium of claim 15, wherein the engagement visualization map comprises a heat map including the engagement level of each of the plurality of timecode intervals displayed concurrently.

17. The computer-readable non-transitory medium of claim 16, wherein the engagement visualization map further comprises an assets pane identifying the plurality of features presented during at least one of the plurality of timecode intervals based on a selection of the at least one of the plurality of timecode intervals by a user of the engagement visualization map.

18. The computer-readable non-transitory medium of claim 15, the method further comprising:
for each of at least some of the plurality of consumers, obtaining marketing data identifying a channel of communication utilized to inform the consumer about the media content; and
for the each of the at least some of the plurality of consumers, correlating the usage data with the marketing data to generate a marketing assessment;
wherein the engagement visualization map includes the marketing assessment.

19. The computer-readable non-transitory medium of claim 15, the method further comprising:
identifying a plurality of consumption profiles based on the usage data for the plurality of consumers;
receiving a the first usage data describing use of the media content by another consumer, the first usage data including timecode information, advertising consumption, and behavioral information corresponding to the use of the media content by the another consumer;
associating the another consumer with one of the plurality of consumption profiles based on the first usage data; and
modifying the media content to provide a customized media content for the another consumer based on the one of the plurality of consumption profiles associated with the another consumer.

20. The computer-readable non-transitory medium of claim 19, the method further comprising:
receiving a second usage data describing use of the customized media content by the another consumer, the second usage data including timecode information, advertising consumption, and behavioral information corresponding to the use of the customized media content by the another consumer; and
assessing a desirability of the customized content to the another consumer based on a comparison of the second usage data with the first usage data.
